(19) United States
(12) Patent Application Publication
(10) Pub. No.: US 2012/0044593 A1
(43) Pub. Date: Feb. 23, 2012

(54) TEMPERATURE INDUCED HEAD SKEW

(75) Inventors: Yong Xiao, Singapore (SG); Qiang Bi, Singapore (SG); Weisung Lee, Singapore (SG); Mingzhong Ding, Singapore (SG); Kiankeong Ooi, Singapore (SG)

(73) Assignee: Seagate Technology LLC, Scotts Valley, CA (US)

(21) Appl. No.: 12/860,585

(22) Filed: Aug. 20, 2010

(51) Int. Cl. G11B 27/36

(52) U.S. Cl. 360/31; G9B/27.052

(57) ABSTRACT

One way to minimize full DC head-skew re-calibrations rendered necessary by changes in storage media drive operating temperature is to compensate for temperature-induced DC head-skew using a known relationship between temperature-induced DC head-skew and storage media operating temperature. More specifically, a first DC head-skew is measured at a first arbitrary temperature of the storage media drive. A second DC head-skew is measured at a second arbitrary temperature of the storage media drive. A DC head-skew correction factor is calculated using the first and second DC head-skews at the first and second arbitrary temperatures. When a multi-head storage media drive is powered-up for operation, a temperature sensor located in the storage media drive assembly measures the current storage media drive temperature. The head-skew correction factor is applied based on the measured temperature to correct the DC head-skew.

### SUMMARY

Implementations described and claimed herein address the foregoing problems by providing a method including calculating a DC head-skew compensation factor by relating a first DC head-skew at a first temperature to a second DC head-skew at a second temperature.

Other implementations are also described and recited herein.

### BRIEF DESCRIPTIONS OF THE DRAWINGS

FIG. 1A illustrates a plan view of an example disc drive assembly including a first actuator aim positioned over a storage disc, a second actuator arm positioned under the storage disc, and a temperature sensor located in the vicinity of the storage disc.

FIG. 1B illustrates an elevation view of the disc drive assembly of FIG. 1A with two skewed transducer heads above and below a storage disc.

FIG. 2 illustrates an elevation view of an example disc drive assembly with two storage discs and four skewed transducer heads.

FIG. 3 illustrates example operations for calculating a temperature-induced DC head-skew correction factor for a multi-head disc drive assembly.

FIG. 4 illustrates example operations for applying a temperature-induced DC head-skew correction factor to a multi-head disc drive assembly.

### DETAILED DESCRIPTIONS

Multi-disk writing (MDW) technology combines two or more transducer heads capable of reading and writing bits of data to/from two or more stacked storage discs sharing a common axis of rotation within a storage media drive. The transducer heads are each attached to an actuator arm in a stack of actuator aims also with a common axis of rotation and are intended to be vertically aligned so that the transducer heads align with the same relative position on each corresponding storage disc.

Exact vertical alignment of the transducer heads is very difficult or entirely unfeasible. As a result, during assembly and certification of the storage media drive, a head-skew calibration process is performed to compensate for any head-skew of the transducer heads. The head-skew calibration process yields parameters that allow the storage media drive to adjust head positioning to accommodate for differences in alignment among multiple heads. After the head-skew calibration process, the storage media drive is able to have high servo performance during head switching seek operations.

The head-skew may have both AC and DC components. The AC component is not significantly affected by temperature change and is not addressed by the presently disclosed technology. The DC component is typically compensated for during certification of the storage media drive. However, the DC skew may change over time or following an environmental event that disrupts the transducer head alignment (e.g., a shock to the storage media drive, a head stack tilt event, and/or and changing environmental factors such as temperature).

After a shock or head stack tilt event, the DC head-skew component may have permanent changes. A power-on full DC head-skew re-calibration can compensate for the permanently changed DC skew. However, the full DC head-skew re-calibration is time consuming and affects drive performance (i.e., results in longer time to ready (TTR)). As a result, the storage media drive may also use quick head-skew checks to quickly determine if DC head-skew exceeds a predetermined triggering threshold, thus indicating that a full DC head-skew re-calibration is necessary. The quick head-skew checks may be performed periodically (e.g., upon start-up of the storage media drive) or only after an event that would likely cause a change in DC head-skew (e.g., a detected shock or head stack tilt event). The quick head-skew checks minimize the number of full DC head-skew re-calibrations, which minimizes time to read (TTR) for the storage media drive.

A storage media drive is typically certified at a known average operating temperature (e.g., 40-50 degrees Celsius). However, when the operating temperature of the storage media drive varies significantly from the temperature during drive certification, the DC head-skew change may be significantly. This is especially likely on small, compact storage media drives with limited cooling capability (e.g., notebook drives). However, the presently disclosed technology is applicable to all types of storage media drives.

If the DC head-skew caused by temperature change is not compensated for, head switching seek operations for the storage media drive will have an acoustic issue and data access time will be impacted. More specifically, the DC head-skew is an error in head position. Head position errors cause sharps changes in voice coil motor current during head switching operations under feedback control. The sharp changes in voice coil motor current create the acoustic issue and data access time suffers. Conversely, if a full DC head-skew re-calibration is performed every time the storage media drive operating temperature significantly changes, TTR will suffer.

One way to minimize full DC head-skew re-calibrations rendered necessary by changes in storage media drive operating temperature is to adjust the triggering threshold used by the quick head-skew checks as a function of operating temperature. However, merely adjusting the triggering threshold used by the quick head-skew checks is insufficient to yield high performance head switching seek operations while maintaining low TTR in storage media drives operating at large temperature variations from the certification temperature. Alternate systems and methods of compensating for temperature-induced DC head-skew are disclosed herein.

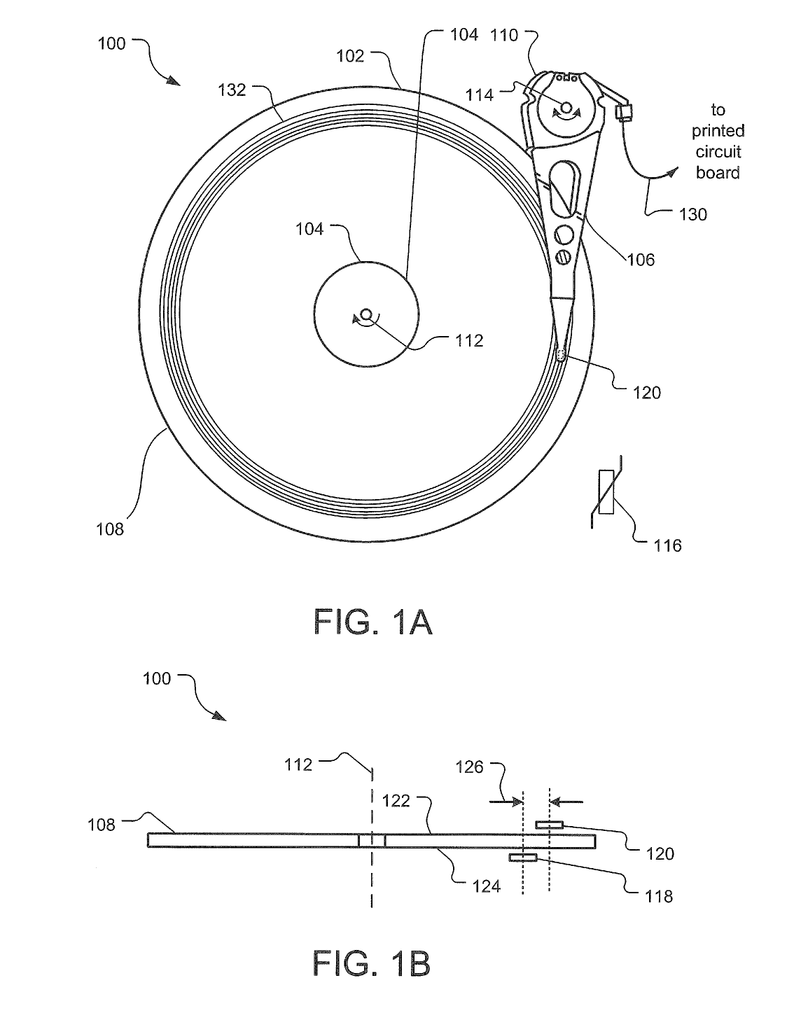

FIG. 1A illustrates a plan view of an example disc drive assembly 100 including a first actuator arm 106 positioned over a storage disc 108, a second actuator arm 110 positioned under the storage disc 108, and a temperature sensor 116 located in the vicinity of the storage disc 108. In various implementations, the storage disc (or media platter) 108 is an optical or magnetic storage medium. Further, the storage disc 108 may be a bit-patterned media. The storage disc 108 includes an outer diameter 102 and an inner diameter 104 between which are a number of data tracks (e.g., data track 132), illustrated by circular lines. The data tracks may be on one or both sides of the storage disc 108. Further, the data tracks are substantially circular and generally concentric with one another and the storage disc 108. In one implementation, the storage disc 108 rotates at a constant high speed about disc axis of rotation 112 as information is written to and read from the data tracks on the storage disc 108. In another implementation, the storage disc 108 rotation speed is variable.

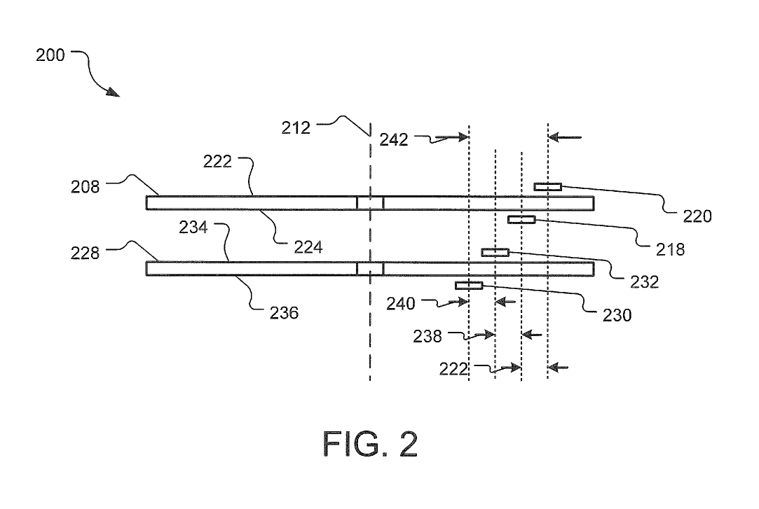

The actuator arms 106, 110 extend over and under the storage disc 108, respectively, to write information to and read information from the storage disc 108. Further, the actuator arms 106, 110 rotate about an actuator axis of rotation 114 during a seek operation to locate desired data track(s) on each side of the storage disc 108. At the distal end of each of the actuator anus 106, 110 facing the storage disc 108 is a transducer head (e.g., transducer head 120), each of which flies in close proximity above/below the storage disc 108 while reading and writing data from/to the storage disc 108. In other implementations, there are more than two transducer heads and actuator arms and more than one storage disc in the disc drive assembly 100 (see e.g., FIG. 2).

One or more flex cables 130 provides the requisite electrical connection paths for the transducer heads while allowing pivotal movement of the actuator arms 106, 110 during operation of the disc drive assembly 100. The flex cable 130 routes along the actuator arm 110 and connects a printed circuit board (PCB) (not shown) to the transducer heads. The PCB typically includes circuitry for controlling the write currents applied to the transducer heads during a write operation and a preamplifier for amplifying read signals generated by the transducer heads during a read operation. Further, the PCB may contain circuitry used to implement the presently disclosed technology described in detail with regard to FIGS. 1B and 2.

The temperature sensor 116 is located within the disc drive assembly 100, preferably near the transducer heads. However, the temperature sensor 116 may be located anywhere within the disc drive assembly 100, so long as the temperature sensor 116 can accurately measure the ambient temperature at the transducer heads. The temperature sensor 116 may be of any type including but not limited to carbon resistors, film thermometers, wire-would thermometers, and coil elements. Further, if the temperature sensor 116 is a thermistor, any materials with a generally linear temperature-resistance relationship may be used for its construction. In other implementations, a thermocouple may be used in place of the thermistor for temperature sensor 116.

FIG. 1B illustrates an elevation view of the disc drive assembly 100 of FIG. 1A with two skewed transducer heads 118, 120 above and below a storage disc 108. The disc drive assembly 100 is exemplary of a 1-disc drive with two transducer heads. As described with respect to FIG. 1A, the storage disc 108 rotates about disc axis of rotation 112 as information is written to and read from the data tracks on the storage disc 108. Both a top surface 122 and a bottom surface 124 of the storage disc 108 are divided into a number of data tracks as described above with respect to FIG. 1A.

Transducer head 120 is configured to read/write data to/from data tracks on the top surface 122 and transducer head 118 is configured to read/write data to/from data tracks on the bottom surface 124. Ideally, transducer head 120 is centered over the same data track on the top surface 122 as transducer head 118 is on the bottom surface 124. However, rather than vertically aligned, transducer head 118 is skewed from transducer head 120 as illustrated by head-skew 126. Head-skew 126 is exaggerated for visual effect and is not drawn to scale. When the disc drive assembly 100 switches from transducer head 120 to transducer head 118, or vice versa, the track difference between the transducer head 120 location on the top surface 122 to transducer head 118 location on the bottom surface 124 is the head-skew 126. The presently disclosed technology is directed at providing formulae for compensating for head-skew 126 rather than adjusting the head-skew 126 itself.

FIG. 2 illustrates an elevation view of an example disc drive assembly 200 with two storage discs 208, 228 and four skewed transducer heads 218, 220, 230, 232. The disc drive assembly 200 is exemplary of a 2-disc drive with four transducer heads. Similar to the 1-disc drive assembly 100 of FIGS. 1A & 1B, the storage discs 208, 228 rotate about disc axis of rotation 212 as information is written to and read from the data tracks on the storage discs 208, 228. Both top surface 222 and bottom surface 224 of the storage disc 208 and top surface 234 and bottom surface 236 of the storage disc 228 are divided into a number of data tracks as described above with respect to FIGS. 1A & 1B.

Transducer head 220 is configured to read/write data to/from data tracks on the top surface 222 of storage disc 208. Transducer head 218 is configured to read/write data to/from data tracks on the bottom surface 224 of storage disc 208. Transducer head 232 is configured to read/write data to/from data tracks on the top surface 234 of storage disc 228. Transducer head 230 is configured to read/write data to/from data tracks on the bottom surface 236 of storage disc 228. Ideally, transducer heads 218, 220, 230, & 232 are centered over the same data track on the bottom surface 224, top surface 222, bottom surface 236, and top surface 234, respectively.

However, rather than vertically aligned, the transducer heads 218, 220, 230, & 232 are skewed from one another as illustrated by head-skews 222, 238, 240, 242. Head-skews 222, 238, 240, 242 are exaggerated for visual effect and not drawn to scale. Head-skew 222 illustrates head-skew between transducer heads 220, 218. Head-skew 238 illustrates head-skew between transducer heads 218, 232. Head-skew 240 illustrates head-skew between transducer heads 232, 230. In this implementation, each head-skew 222, 238, 240 corresponds to head-skew between adjacent transducer heads and are approximately equal and varying in the same direction. In other implementations, head-skew between adjacent transducer heads may not be equal or skewed in the same direction. The total head-skew 242 illustrates head-skew between transducer heads 220, 230, the uppermost and bottommost transducer heads in the disc drive assembly 200. In still other implementations, the disc drive assembly may contain more than two storage disks with data tracks on one or both sides of the storage discs. Further, there may be more than four transducer heads in the disc drive assembly.

In an example implementation, a 2-disc drive test assembly with four transducer heads, similar to that of FIG. 2, was aligned at 5 degrees Celsius. The temperature of the test assembly was increased to 55 degrees Celsius and the head-skew of each pair of adjacent transducer heads was measured as they were moved from the inner diameter to the outer diameter of the test assembly. The measured DC head-skew between each pair of adjacent heads was generally linear as the transducer heads were moved from the inner diameter to the outer diameter of the test assembly. Further, even in implementations where the DC head-skew does not change linearly as the transducer heads are moved from the inner diameter to the outer diameter of a storage media, the temperature compensation factor contemplated herein will still apply to tracks at or near the inner diameter as well as tracks at or near the outer diameter of the storage media. There was also some measured AC component head-skew and the linearity of the DC component head-skew decreased close to the outer diameter of the test assembly. However, the linear DC head-skew was dominant.

A measured head-skew between each pair of adjacent heads ranged from approximately 12 to 28 tracks, with each pair of adjacent heads varying by no more than 10 tracks from inner diameter to the outer diameter of the test assembly. In one implementation, the threshold criteria for executing a full power-on DC head-skew re-calibration is set around 30 tracks. While, the skew of individual pair of adjacent heads at 55 degrees Celsius is not sufficient to trigger the full power-on DC head-skew re-calibration, the skew between each pair of adjacent heads is combined to find the head-skew between the top-most transducer head and the bottom-most transducer head in the test assembly. As a result, the skew between the top-most transducer head and the bottom-most transducer head in the test assembly ranged from approximately 52 to 65 tracks, which is significantly above the threshold criteria for executing a full power-on DC head-skew re-calibration.

If the temperature-induced DC component head-skew is compensated for at each transducer head in a linear manner from the inner diameter to the outer diameter of the test assembly, any residual DC error is small and can be compensated for using a servo control loop, gain scheduling, and/or other known compensation techniques during head switching operations.

In another example implementation, head-skew of a 2-disc drive test assembly with four transducer heads was tracked from 0 to 60 degrees Celsius. A generally linear slope of DC head-skew versus temperature was observed for both adjacent heads in the 2-disc drive test assembly and for head-skew between the top-most transducer head and the bottom-most transducer head in the test assembly. For example, the head-skew between the top-most transducer head and the bottom-most transducer head ranged from approximately +49 tracks at 0 degrees Celsius to −7 tracks at 60 degrees Celsius, with an approximately linear slope between the two temperature extremes. As a result, temperature-induced DC head-skew may be primarily compensated for using a linear function. Many power-on DC head-skew re-calibrations may be avoided if temperature-induced DC head-skew is compensated for using a linear function based on operating temperature of a disc drive.

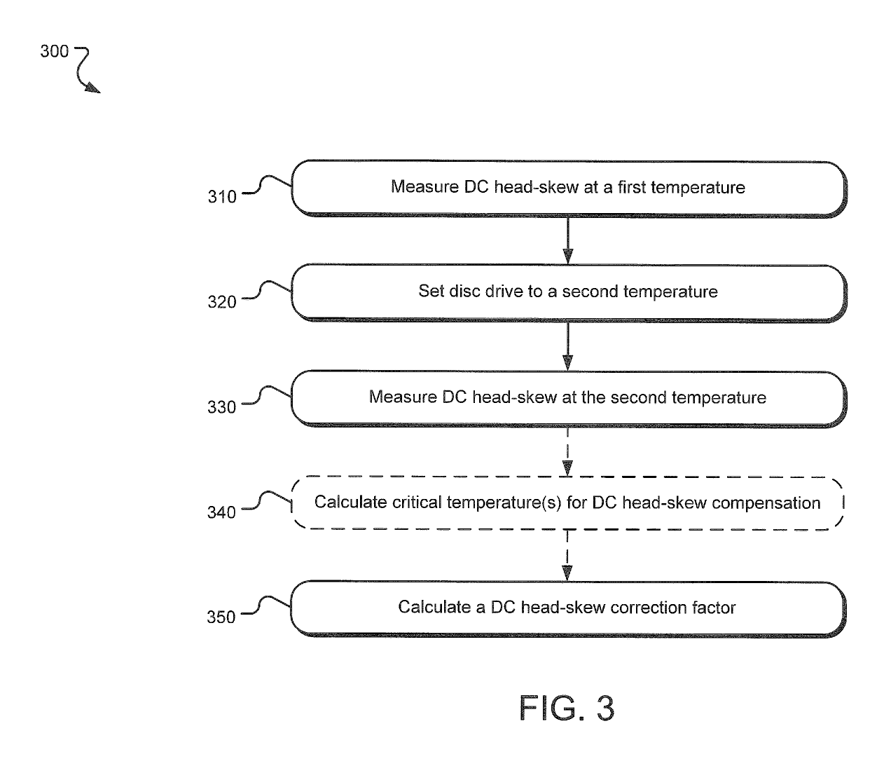

FIG. 3 illustrates example operations 300 for calculating a temperature-induced DC head-skew correction factor for a multi-head disc drive assembly. In measuring operation 310, DC head-skew (DCskew₁) is measured at a first arbitrary temperature (T₁) of the disc drive. In one implementation, DCskew₁ equals approximately 0 tracks at 55 degrees Celsius (T₁). In setting operation 320, the disc drive temperature is reset to a second arbitrary temperature (T₂). In measuring operation 330, DC head-skew (DCskew₂) is measured at T₂. In one implementation, DCskew₂ equals approximately 28 tracks at 25 degrees Celsius (T₂).

In an optional calculating operation 340, critical temperature(s) (T_{c}) for DC head-skew compensation are calculated. A DC head-skew correction factor is only necessary when the drive operating temperature falls outside of a range defined by T_{c}. For example, when the code space and/or processor bandwidth required for implementing calculating operation 350 for the entire operating temperature range of the disc drive is too great, optional calculating operation 340 may be used. Since optional calculating operation 340 is a simplified way to compensate for temperature-induced DC head-skew, less code space and/or processor bandwidth are required. After calculating operation 340, calculating operation 350 yields DC head-skew correction factor(s) only for temperature ranges outside the range(s) defined by T_{c}.

In implementations that do not utilize calculating operation 340, the operations 300 proceed directly from measuring operation 330 to calculating operation 350. Other individual operations of operations 300 may also be optional in various implementations of the presently disclosed technology. In calculating operation 350, the DC head-skew correction factor (e.g., DC head-skew slope between T₁ and T₂) is calculated by relating DCskew₁ at T₁ to DCskew₂ at T₂. The following formula is one implementation of this relation.

$$correctionfactor = \frac{{DCskew}_{2} - {DCskew}_{1}}{{T}_{2} - {T}_{1}}$$

Since in the example implementation referenced above, DCskew₁ equals approximately 0, the slope of DC head-skew becomes:

$$correctionfactor = \frac{{DCskew}_{2}}{{T}_{2} - {T}_{1}}$$

The DC head-skew correction factor may be stored in memory (e.g., servo adaptive parameters (SAP) or global memory) or it may be computed on-the-fly using DC head-skew and corresponding temperature values stored in memory. Further, more than two DC head-skew and temperature values may be used to calculate the DC head-skew correction factor. In one implementation, multiple correction factors between multiple pairs of measured DC head-skew (DCskewₓ) at temperature points (Tₓ) may be averaged to find an overall DC head-skew correction factor. In another implementation, two different correction factors between two pairs of measured DC head-skew may be used to calculate two DC head-skew correction factors (e.g., one for higher temperature operation and one for lower temperature operation). More than two DC head-skew measurements may also be used to calculate separate DC head-skew correction factors for more than two temperature bands.

The servo control loop for the multi-head disc drive assembly is able to compensate for some DC skew without a DC head-skew correction factor (e.g., 25 tracks of DC head-skew). Using a line plotted between DCskew₁ at T₁ and DCskew₂ at T₂, a critical temperature (T_{c}) may be found at the maximum DC head-skew that the servo control loop can compensate for (e.g., DCskew_{c}). For example, when DCskew₁ equals approximately 0 tracks at 55 degrees Celsius and DCskew₂ equals approximately 28 tracks at 25 degrees Celsius, DCskew_{c} may equal approximately 25 tracks at 30 degrees Celsius (T_{c}). A low-temperature DC head-skew correction factor may be applied when the disc drive temperature is below T_{c}, while no DC head-skew correction is applied when the disc drive temperature is above T_{c}.

Further, if the disc drive temperature is expected to rise above a second critical temperature (T_{c′}) corresponding to the maximum number of tracks that may be compensated for using the servo control loop (e.g., −25 tracks of DC head-skew), a high-temperature DC head-skew correction factor may also be calculated using a similar procedure as the low-temperature DC head-skew correction factor. In some implementations, the high-temperature DC head-skew correction factor and the low-temperature DC head-skew correction factor are the same.

For example, when DCskew₂ equals approximately 28 tracks at 25 degrees Celsius and DCskew₁ equals approximately 0 tracks at 55 degrees Celsius, high-temperature DCskew_{c′} may equal approximately −25 tracks at 80 degrees Celsius (T_{c′}). When there is a high critical temperature (e.g., 80 degrees Celsius) and a low critical temperature (e.g., 30 degrees Celsius), so long as the disc drive temperature remains between 30 degrees and 80 degrees Celsius, no head-skew correction factor is needed. However, a low-temperature DC head-skew correction factor is applied if the disc drive temperature drops below the low critical temperature (e.g., 30 degrees Celsius) and a high-temperature DC head-skew correction factor is applied if the disc drive temperature rises above the high critical temperature (e.g., 80 degrees Celsius). Further, if the slope of DC head-skew over temperature is non-linear, multiple DC head-skew correction factors may be calculated for temperature ranges below the low critical temperature and/or above the high critical temperature.

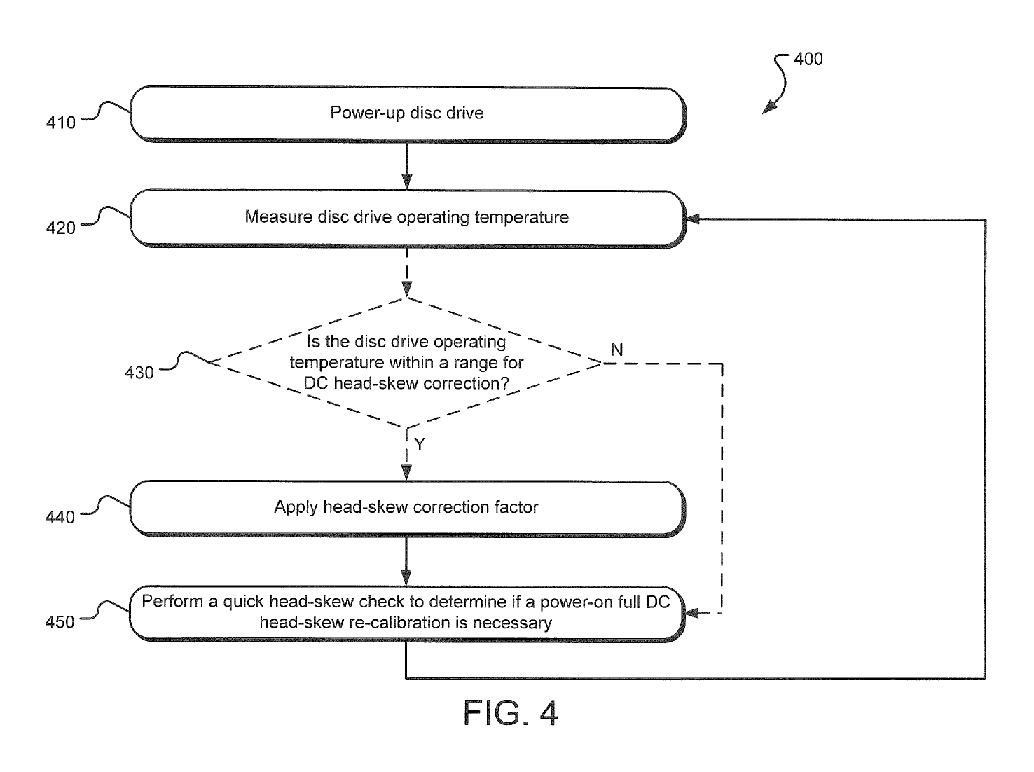

FIG. 4 illustrates example operations 400 for applying a temperature-induced DC head-skew correction factor to a multi-head disc drive assembly. In a power-up operation 410, the multi-head disc drive assembly is powered-up for operation. In measuring operation 420, a temperature sensor located somewhere in the disc drive assembly (preferably near the transducer heads) measures the current disc drive temperature (Tₓ).

In one implementation, a correctionfactor parameter (see e.g., FIG. 3) is only available for certain temperature ranges. In optional decision operation 430, it is determined whether the disc drive operating temperature is within a range for DC head-skew correction. If the disc drive operating temperature is not within a range for DC head-skew correction, the operations 400 proceed to performing operation 450 (described below).

If the disc drive operating temperature is within a range for DC head-skew correction, than in applying operation 440, a head-skew correction factor corresponding to the relevant range for DC head-skew correction is applied to correct the DC head-skew. For example, a low-temperature DC head-skew correction factor may be applied when the disc drive temperature is below a critical temperature, while no DC head-skew correction is applied when the disc drive temperature is above the critical temperature. The critical temperature refers to the number of tracks of DC head-skew that the servo control loop is able to compensate for without a DC head-skew correction factor.

In implementations that do not utilize decision operation 430, the operations 400 proceed directly from measuring operation 420 to applying operation 440. Other individual operations of operations 400 may also be optional in various implementations of the presently disclosed technology. In applying operation 440, a head-skew correction factor is applied based on the measured temperature to correct the DC head-skew. For example, if the correctionfactor parameter was calculated as described above with regard to FIG. 3, then a DC head-skew correction value at Tₓ (DCskewₓ) is calculated as follows.

DCskewₓ=DCskew₂+correctionfactor*(Tₓ−T₂)

In performing operation 450, a quick head-skew check is performed to determine if a power-on full DC head-skew re-calibration is necessary. Assuming that the power-on full DC head-skew re-calibration is unnecessary due perhaps to the application of the correction factor applied in operation 440, the disc drive is ready for operation. After application of the correction factor, any residual DC head-skew should be small enough that the servo control loop can compensate for it without a power-on full DC head-skew re-calibration, even at extreme temperature conditions of the disc drive assembly. As a result, the power-on full DC head-skew re-calibration will be skipped unless a shock to the storage media drive or a head stack tilt event has occurred. This will keep adequate drive servo performance while minimizing TTR.

Operations 420-450 may be periodically repeated over time, during certain drive functions, or during drive idle time. Further, operations 420-450 may be repeated only when a significant temperature change has been detected. Still further, operations 410-450 may be repeated every time the disc drive assembly is powered up or only the first time the disc drive assembly is powered up.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
calculating a DC head-skew compensation factor by based on a first DC head-skew at a first temperature and a second DC head-skew at a second temperature.

2. The method of claim 1, further comprising:
measuring the first DC head-skew at the first temperature; and
measuring the second DC head-skew at the second temperature.

3. The method of claim 1, wherein the calculating operation includes solving the following equation:
$$correctionfactor = \frac{{DCskew}_{2} - {DCskew}_{1}}{{T}_{2} - {T}_{1}} ,$$
wherein
correction factor equals the DC head-skew compensation factor;
DCskew₁ equals the first DC head-skew;
DCskew₂ equals the second DC head-skew;
T₁ equals the first temperature; and
T₂ equals the second temperature.

4. The method of claim 1, wherein the first DC head-skew is equal to approximately zero and the calculating operation includes solving the following equation:
$$correctionfactor = \frac{{DCskew}_{2}}{{T}_{2} - {T}_{1}} ,$$
wherein
correction factor equals the DC head-skew compensation factor;
DCskew₂ equals the second DC head-skew;
T₁ equals the first temperature; and
T₂ equals the second temperature.

5. The method of claim 1, further comprising:
applying the DC head-skew compensation factor to a stack of two or more transducer heads at an operating temperature to generate a head-skew compensation value;
applying the head-skew compensation value to compensate for temperature-induced DC head-skew of the two or more transducer heads at the operating temperature.

6. The method of claim 1, further comprising:
performing a quick head-skew check; and
performing a power-on full DC head-skew re-calibration, if the quick head-skew check yields a DC head-skew that exceeds a threshold value.

7. The method of claim 6, wherein the threshold value corresponds to a maximum amount of DC head-skew that may be compensated for using a servo control loop.

8. The method of claim 1, wherein the first DC head-skew, first temperature, second DC head-skew, and second temperature are stored in a servo adaptive parameters table.

9. The method of claim 5, wherein the applying operation includes solving the following equation:
DCskewₓ=DCskew₂+correctionfactor*(Tₓ−T₂), wherein
correction factor equals the DC head-skew compensation factor;
DCskewₓ equals a DC head-skew compensation value at the operating temperature;
DCskew₂ equals the second DC head-skew;
Tₓ equals the operating temperature; and
T₂ equals the second temperature.

10. A storage media drive comprising:
a first transducer head at an operating temperature; and
a second transducer head at the operating temperature with a temperature-induced DC skew from the first transducer head, wherein the storage media drive is configured to compensate for the temperature-induced DC skew based on a temperature-dependent DC head-skew compensation factor and the operating temperature.

11. The storage media drive of claim 10, wherein the DC head-skew compensation factor is obtained from a first measured DC head-skew at a first temperature and a second measured DC head-skew at a second temperature.

12. The storage media drive of claim 10, further comprising:
a temperature sensor configured to measure the operating temperature.

13. The storage media drive of claim 10, further comprising:
a third transducer head at the operating temperature, wherein a first temperature-induced DC skew between the first and second transducer heads and a second temperature-induced DC skew between the second and third transducer heads is compensated for using the DC head-skew compensation factor and the operating temperature.

14. The storage media drive of claim 10, wherein the DC head-skew compensation factor is applied to the first and second transducer heads at the operating temperature to generate a head-skew compensation value, which compensates for the temperature-induced DC skew between the first and second transducer heads at the operating temperature.

15. A method of compensating for temperature-induced DC head-skew in a stack of two or more transducer heads, comprising:
measuring an operating temperature of the stack of two or more transducer heads; and
applying a DC head-skew compensation factor to the stack of two or more transducer heads to compensate for the temperature-induced DC head-skew of the two or more transducer heads if the operating temperature is within a temperature range for DC head-skew correction.

16. The method of claim 15, further comprising:
calculating the DC head-skew compensation factor based on a first DC head-skew at a first temperature and a second DC head-skew at a second temperature.

17. The method of claim 15, wherein the temperature range for DC head-skew correction is defined by a magnitude of DC head-skew that exceeds a magnitude correctable using a servo control loop.

18. The method of claim 15, further comprising:
applying the DC head-skew compensation factor to a stack of two or more transducer heads. at the operating temperature to generate a head-skew compensation value; and
applying the head-skew compensation value to compensate for the temperature-induced DC head-skew of the two or more transducer heads at the operating temperature.

19. The method of claim 15, wherein the temperature range for DC head-skew correction lies above or below a critical temperature.

20. The method of claim 15, wherein the temperature range for DC head-skew correction lies below a first critical temperature and above a second critical temperature.
